(19) United States
(12) Patent Application Publication
(10) Pub. No.: US 2023/0360286 A1
(43) Pub. Date: Nov. 9, 2023

(54) IMAGE PROCESSING METHOD AND APPARATUS, ELECTRONIC DEVICE AND STORAGE MEDIUM

(71) Applicant: Beijing Zitiao Network Technology Co., Ltd., Beijing (CN)

(72) Inventors: Zhihong YUAN, Beijing (CN); Chunlei RUAN, Beijing (CN); Wenqiang CAI, Beijing (CN); Chenxiang ZHAO, Beijing (CN); Chenglin ZHOU, Beijing (CN)

(21) Appl. No.: 18/344,759

(22) Filed: Jun. 29, 2023

Related U.S. Application Data
(63) Continuation-in-part of application No. PCT/CN2021/132592, filed on Nov. 23, 2021.
Application No. PCT/CN2021/132592 is a continuation-in-part of application No. PCT/CN2021/132594, filed on Nov. 23, 2021.

(30) Foreign Application Priority Data
Dec. 31, 2020 (CN) 202011630469.5
Dec. 31, 2020 (CN) 202011630524.0

(51) Int. Cl. G06T 11/00; G06T 5/00; G06T 7/90; G06F 3/04847; G06F 3/04845

(52) U.S. Cl. CPC G06T 11/001; G06T 5/002; G06T 5/003; G06T 7/90; G06F 3/04847; G06F 3/04845; G06T 2200/24; G06T 2210/62; G06T 2207/10024; G06F 2203/04804

(57) ABSTRACT

An image processing method and apparatus, an electronic device, and a storage medium are provided, the method comprising: obtaining luminance value of respective pixel points in image layer to be processed; determining pixel point in image layer to be processed whose luminance value satisfies first preset threshold relationship or second preset threshold relationship with luminance value of anchor point in area to be adjusted as target pixel point; when first preset threshold relationship is satisfied, performing target effect adjustment on target pixel point according to input parameter of first target effect item to generate adjusted image; when second preset threshold relationship is satisfied, performing adjustment on target effect parameter of target pixel point according to input parameter of second target effect item and preset mapping table to generate adjusted image; and determining result image according to adjusted image and image to be processed.

### CROSS-REFERENCE TO RELATED APPLICATIONS

This application is a continuation-in-part of International Application No. PCT/CN2021/132594 and International Application No. PCT/CN2021/132592, where International Application No. PCT/CN2021/132594 claims priority to Chinese Patent Application No. 202011630524.0 filed with China National Intellectual Property Administration on Dec. 31, 2020 and entitled with “Image Processing Method and Apparatus, Electronic Device and Storage Medium”, and International Application No. PCT/CN2021/132592 claims priority to Chinese Patent Application No. 202011630469.5 filed with China National Intellectual Property Administration on Dec. 31, 2020 and entitled with “Image Processing Method and Apparatus, Electronic Device and Storage Medium”, the disclosure of which are incorporated herein by reference in their entireties.

### TECHNICAL FIELD

The present disclosure relates to the technical field of image processing, and in particular, to an image processing method and apparatus, an electronic device, and a storage medium.

### BACKGROUND

With the development of the intelligent terminal technology, the functions of the intelligent terminal to collect images are becoming more and more powerful, and various application programs used for performing corresponding processing on the images obtained by the intelligent terminal are becoming more and more.

Although these application programs can perform processing on the obtained image information, such as beautifying and adding special effects, and the like, the processing of image by existing application programs is often in a single form, and usually only an overall adjustment can be carried out on the image, which does not satisfy users' processing requirement for the detail presentation degree of image and users' diversified processing requirements for image details.

### SUMMARY

The present disclosure provides an image processing method and apparatus, an electronic device, and a storage medium, which are used to solve the technical problem that the current image processing form is relatively simple and cannot satisfy the users' processing requirements for the image detail presentation degree and users' diversified processing requirements for image details.

In a first aspect, the present disclosure provides an image processing method, including:
obtaining a luminance value of respective pixel points in an image layer to be processed, where the image layer to be processed includes a feather image layer corresponding to an area to be adjusted in an image to be processed;
determining a pixel point in the image layer to be processed whose luminance value satisfies a first preset threshold relationship or a second preset threshold relationship with a luminance value of an anchor point in the area to be adjusted as a target pixel point;
when determining a pixel point in the image layer to be processed whose luminance value satisfies the first preset threshold relationship with the luminance value of the anchor point in the area to be adjusted as the target pixel point, performing a target effect adjustment on the target pixel point according to an input parameter of a first target effect item to generate an adjusted image, where the first target effect item is used to represent a detail presentation degree of an image;
when determining a pixel point in the image layer to be processed whose luminance value satisfies the second preset threshold relationship with the luminance value of the anchor point in the area to be adjusted as the target pixel point, performing an adjustment on a target effect parameter of the target pixel point according to an input parameter of a second target effect item and a preset mapping table to generate an adjusted image; and
determining a result image according to the adjusted image and the image to be processed.

In a second aspect, the present disclosure provides an image processing apparatus, including:
an obtaining module, configured to obtain a luminance value of respective pixel points in an image layer to be processed, where the image layer to be processed includes a feather image layer corresponding to an area to be adjusted in an image to be processed;
a determining module, configured to determine a pixel point in the image layer to be processed whose luminance value satisfies a first preset threshold relationship or a second preset threshold relationship with a luminance value of an anchor point in the area to be adjusted as a target pixel point;
an adjusting module, configured to, when determining a pixel point in the image layer to be processed whose luminance value satisfies the first preset threshold relationship with the luminance value of the anchor point in the area to be adjusted as the target pixel point, perform a target effect adjustment on the target pixel point according to an input parameter of a first target effect item to generate an adjusted image, where the first target effect item is used to represent a detail presentation degree of an image; and configured to, when determining a pixel point in the image layer to be processed whose luminance value satisfies the second preset threshold relationship with the luminance value of the anchor point in the area to be adjusted as the target pixel point, perform an adjustment on a target effect parameter of the target pixel point according to an input parameter of a second target effect item and a preset mapping table to generate an adjusted image; and
the determining module is further configured to determine a result image according to the adjusted image and the image to be processed.

In a third aspect, the present disclosure also provides an electronic device, including:
at least one processor; and
a memory, configured to store executable instructions of the at least one processor;
where the at least one processor is configured to execute any one of the possible image processing methods in the first aspect by executing the executable instructions.

In a fourth aspect, an embodiment of the present disclosure further provides a computer readable storage medium on which a computer program is stored; and the computer program, when executed by at least one processor, implements any one of the possible image processing methods in the first aspect.

In a fifth aspect, an embodiment of the present disclosure further provides a computer program product, including a computer program, which, when executed by at least one processor, implements any one of the possible image processing methods in the first aspect.

In a sixth aspect, an embodiment of the present disclosure provides a computer program, which, when executed by at least one processor, implements any one of the possible image processing methods in the first aspect.

The present disclosure provides an image processing method and apparatus, an electronic device and a storage medium. By obtaining a luminance value of respective pixel points in an image layer to be processed; then when determining a pixel point in the image layer to be processed whose luminance value satisfies the first preset threshold relationship with the luminance value of the anchor point in the area to be adjusted as the target pixel point, performing a target effect adjustment on the target pixel point according to an input parameter of a first target effect item to generate an adjusted image, where the first target effect item is used to represent a detail presentation degree of an image; and when determining a pixel point in the image layer to be processed whose luminance value satisfies the second preset threshold relationship with the luminance value of the anchor point in the area to be adjusted as the target pixel point, performing an adjustment on a target effect parameter of the target pixel point according to an input parameter of a second target effect item and a preset mapping table to generate an adjusted image; and finally, determining a result image according to the adjusted image and the image to be processed, so as to achieve the processing effect of local detail enhancement or detail blurring of the image to be processed, and achieve the processing effect that various target effect items can be applied to the local scope of the image to be processed, and the image local adjustment can be realized, so that the application scope of the content and manner of image editing can be broadened, so that users can adjust the local and details to enrich the image processing manner.

### BRIEF DESCRIPTION OF DRAWINGS

In order to illustrate technical solutions in the embodiments of the present disclosure or in the prior art more clearly, the following will briefly introduce the accompanying drawings needed in the description of the embodiments or the prior art. Obviously, the accompanying drawings in the following description are some embodiments of the present disclosure. For those of ordinary skill in the art, other drawings may also be obtained from these drawings without creative efforts.

FIG. 1 is an application scenario diagram of an image processing method illustrated in an embodiment of the present disclosure.

FIG. 2 is a schematic flowchart of an image processing method illustrated in an embodiment of the present disclosure.

FIG. 3 is a schematic flowchart of an image processing method illustrated in an embodiment of the present disclosure.

FIG. 4 is a schematic diagram of a grayscale image illustrated in an embodiment of the present disclosure.

FIG. 5 is a schematic diagram of a luminance image illustrated in an embodiment of the present disclosure.

FIG. 6 is a schematic diagram of detail presentation degree blurring illustrated in an embodiment of the present disclosure.

FIG. 7 is a schematic diagram of detail presentation degree enhancement illustrated in an embodiment of the present disclosure.

FIG. 8 is a schematic diagram of interface for adjusting a scope of an area to be adjusted illustrated in an embodiment of the present disclosure.

FIG. 9 is a schematic diagram of a result of local detail presentation degree of enhancement illustrated in an embodiment of the present disclosure.

FIG. 10 is a schematic flowchart of the image processing method illustrated in an embodiment of the present disclosure.

FIG. 11 is a schematic diagram of interface for selecting an area to be adjusted illustrated in an embodiment of the present disclosure.

FIG. 12 is a schematic diagram of interface for adjusting a scope of an area to be adjusted illustrated in an embodiment of the present disclosure.

FIG. 13 is a schematic diagram of an image layer to be processed illustrated in an embodiment of the present disclosure.

FIG. 14 is a schematic diagram of interface for adjusting single-item of image local illustrated in an embodiment of the present disclosure.

FIG. 15 is a schematic diagram of interface for adjusting multiple-items of image local illustrated in an embodiment of the present disclosure.

FIG. 16 is a schematic structural diagram of an image processing apparatus illustrated in an embodiment of the present disclosure.

FIG. 17 is a schematic structural diagram of an electronic device illustrated in an embodiment of the present disclosure.

### DESCRIPTION OF EMBODIMENTS

Embodiments of the present disclosure will be described in more detail below with reference to the accompanying drawings. While certain embodiments of the present disclosure are illustrated in the drawings, it should be understood that the present disclosure may be realized in various forms and should not be construed as limited to the embodiments set forth herein, but rather the embodiments are provided for the purpose of a more thorough and complete understanding of the present disclosure. It should be understood that the drawings and embodiments of the present disclosure are only for exemplary purposes, and are not intended to limit the protection scope of the present disclosure.

It should be understood that the various steps described in the method embodiments of the present disclosure may be performed in different orders and/or in parallel. Furthermore, method embodiments may include additional steps and/or omit performing the illustrated steps. The scope of the present disclosure is not limited in this regard.

As used herein, the term “including” and variations thereof are open-ended inclusions, i.e., “including but not limited to”. The term “based on” is “at least partially based on”. The term “one embodiment” means “at least one embodiment”; the term “another embodiment” means “at least one additional embodiment”. The term “some embodiments” means “at least some embodiments”. Relevant definitions of other terms will be given in the description below.

It should be noted that concepts such as “first” and “second” mentioned in the present disclosure are only used to distinguish different apparatuses, modules or units, and are not used to limit the order of functions performed by these apparatuses, modules or units or the interdependence thereof.

It should be noted that the modifications of “a” and “a plurality” mentioned in the present disclosure are illustrative rather than restrictive, and those skilled in the art should understand that unless the context clearly indicates otherwise, they should be understood as “one or a plurality of”.

At present, the functions of smart terminals for collecting images are becoming more and more powerful, so there are more and more application programs for processing corresponding images obtained by smart terminals. For example, these application programs can beautify and add special effects to the obtained image information. However, these existing application programs often process images in a relatively simple form, and only an overall adjustment can be carried out on the images, which does not satisfy users' processing requirement for the detail presentation degree of image and users' diversified processing requirements for image details. Specifically, for the convenience of users, the existing image processing application programs usually process the image globally, or process by concentrating on a specific area of the image (for example, eye, lip, cheek, and the like). However, users cannot make a finer-grained adjustment and polishing to a local scope of the image based on their own higher requirements for the detail presentation degree, and users cannot adjust an arbitrarily local scope of the image according to their own processing requirements.

The embodiments provided by the present disclosure aim at: obtaining a luminance value of respective pixel points in an image layer to be processed; after that, when determining a pixel point in the image layer to be processed whose luminance value satisfies the first preset threshold relationship with the luminance value of the anchor point in the area to be adjusted as the target pixel point, performing a target effect adjustment on the target pixel point according to an input parameter of a first target effect item to generate an adjusted image, where the first target effect item is used to represent a detail presentation degree of an image; and when determining a pixel point in the image layer to be processed whose luminance value satisfies the second preset threshold relationship with the luminance value of the anchor point in the area to be adjusted as the target pixel point, performing an adjustment on a target effect parameter of the target pixel point according to an input parameter of a second target effect item and a preset mapping table to generate an adjusted image; finally, determining a result image according to the adjusted image and the image to be processed. Hence, embodiments provided by the present disclosure realize the processing effect of local detail enhancement or detail blurring of the image to be processed. Therefore, by controlling an effect scope in the image where the target effect item representing a detail presentation degree of an image takes effects, the user can make finer-grained adjustment and polishing of the image for any local position of the image, so as to satisfy the users' higher usage requirements. Meanwhile, embodiments provided by the present disclosure also apply various target effect items in the local scope of the image to be processed to realize the image local adjustment, and further broaden the application scope of the image editing contents and manners, enabling users to make adjustment for the local and details, so as to enrich the image processing manners and realize that the basic editing projects such as contrast, luminance, saturation, light perception, color temperature and hue can be applied in the local scope of the image to be processed, and the application scope of the editing content can be widened, so that users can make adjustment based on the local and details, thus broadening the processing manners of various effects of images.

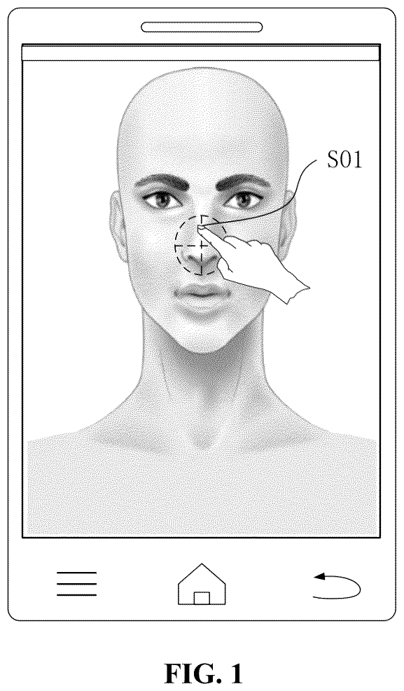

FIG. 1 is an application scenario diagram of an image processing method illustrated in an embodiment of the present disclosure. As illustrated in FIG. 1, the image processing method provided by the present embodiment can be applied to a terminal device 100, where the terminal device 100 can be a device such as a personal computer, a notebook computer, a tablet computer, a smart phone, a wearable electronic device, a smart home device, and the like. When the user performs local adjustment of the image to be processed, under the prompt of an adding control point icon S01, a control point can be added in the area to be adjusted of the image to be processed, where an anchor point is determined by the control point, and the anchor point is taken as the center point to determine an image layer to be processed corresponding to the area to be adjusted. Then, when determining a pixel point in the image layer to be processed whose luminance value satisfies the first preset threshold relationship with the luminance value of the anchor point in the area to be adjusted as the target pixel point, a target effect adjustment is performed on the target pixel point according to an input parameter of a first target effect item to generate an adjusted image, where the first target effect item is used to represent a detail presentation degree of an image, and when determining a pixel point in the image layer to be processed whose luminance value satisfies the second preset threshold relationship with the luminance value of the anchor point in the area to be adjusted as the target pixel point, an adjustment is performed on a target effect parameter of the target pixel point according to an input parameter of a second target effect item and a preset mapping table (e.g., a preset color look up table (LUT)) to generate an adjusted image; finally, a result image is determined according to the adjusted image and the image to be processed, so as to achieve the processing effect of enhancing local details or blurring the details of the image to be processed and achieve the processing effect of local adjustment of the area to be adjusted of the image to be processed. The image processing method will be described in detail below through several specific implementations.

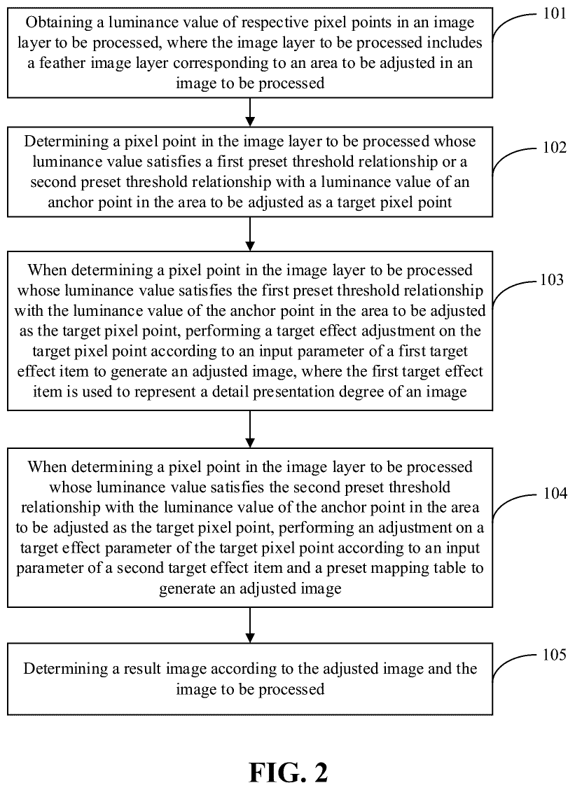

FIG. 2 is a schematic flowchart of an image processing method illustrated in an embodiment of the present disclosure. As illustrated in FIG. 2, the image processing method provided by the present embodiment includes:

Step 101: obtaining a luminance value of respective pixel points in an image layer to be processed, where the image layer to be processed includes a feather image layer corresponding to an area to be adjusted in an image to be processed.

In this step, it is worth noting that the feather image layer has a feathering effect, where the transparency of the feather image layer is gradually reduced from the center to the edge, which blurs an inner-and-outer connection portion of the feather image layer and has a gradual change effect, so as to achieve an effect of natural connection. In this way, when adjusting the image layer to be processed, the effect of natural connection can be achieved between the image layer to be processed and other unprocessed areas in the image to be processed.

Step 102: determining a pixel point in the image layer to be processed whose luminance value satisfies a first preset threshold relationship or a second preset threshold relationship with a luminance value of an anchor point in the area to be adjusted as a target pixel point.

Specifically, the luminance value of the selected target pixel point and the luminance value of the anchor point satisfy a first preset threshold relationship or a second preset threshold relationship, where the anchor point is the center point of the area to be adjusted. It can be understood that since the image layer to be processed is the feather image layer corresponding to the area to be adjusted, that is, the scope corresponding to the image layer to be processed and the scope corresponding to the area to be adjusted are the same scope, therefore, the above anchor point is the center point of both the area to be adjusted and the image layer to be processed. It should be noted that, in order to make the effect of the local processing more natural, a pixel point having a corresponding luminance value relationship with the center point of the area to be adjusted may be selected as the target pixel point for processing.

Step 103: when determining a pixel point in the image layer to be processed whose luminance value satisfies the first preset threshold relationship with the luminance value of the anchor point in the area to be adjusted as the target pixel point, performing a target effect adjustment on the target pixel point according to an input parameter of a first target effect item to generate an adjusted image, where the first target effect item is used to represent a detail presentation degree of an image.

Specifically, target effect adjustment is performed on the target pixel point according to the input parameter of the first target effect item to generate an adjusted image, where the first target effect item is used to represent the detail presentation degree of the image.

Step 104: when determining a pixel point in the image layer to be processed whose luminance value satisfies the second preset threshold relationship with the luminance value of the anchor point in the area to be adjusted as the target pixel point, performing an adjustment on a target effect parameter of the target pixel point according to an input parameter of a second target effect item and a preset mapping table to generate an adjusted image.

Specifically, after obtaining the luminance value of respective pixel points in the image layer to be processed and determining a pixel point in the image layer to be processed whose luminance value satisfies the second preset threshold relationship with the luminance value of the anchor point in the area to be adjusted as the target pixel point, the target effect parameter of the target pixel point can be adjusted according to an input parameter of the second target effect item and a preset mapping table (for the convenience of explanation, a preset LUT is selected as the preset mapping table to be described below), so as to generate the adjusted image. In addition, in the present embodiment, the above preset LUT can be configured according to the requirements of products and effects, so as to match different processing requirements.

S105: determining a result image according to the adjusted image and the image to be processed.

After the adjusted image is generated, a result image may also be generated according to the adjusted image and the image to be processed, so as to present processing effects of local detail enhancement or local detail blurring or local adjustment in the result image.

In the present embodiment, by the means of: obtaining a luminance value of respective pixel points in an image layer to be processed; then when determining a pixel point in the image layer to be processed whose luminance value satisfies the first preset threshold relationship with the luminance value of the anchor point in the area to be adjusted as the target pixel point, performing a target effect adjustment on the target pixel point according to an input parameter of a first target effect item to generate an adjusted image, where the first target effect item is used to represent a detail presentation degree of an image; and when determining a pixel point in the image layer to be processed whose luminance value satisfies the second preset threshold relationship with the luminance value of the anchor point in the area to be adjusted as the target pixel point, performing an adjustment on a target effect parameter of the target pixel point according to an input parameter of a second target effect item and a preset mapping table to generate an adjusted image; finally, determining a result image according to the adjusted image and the image to be processed, so as to realize the processing effect of local detail enhancement or detail blurring of the image to be processed. Besides, various target effect items can be applied to the local scope of the image to be processed, and the image local adjustment can be realized, so that the application scope of the content and manner of image editing can be broadened, so that users can adjust the local and details to enrich the processing effect of the image processing manner.

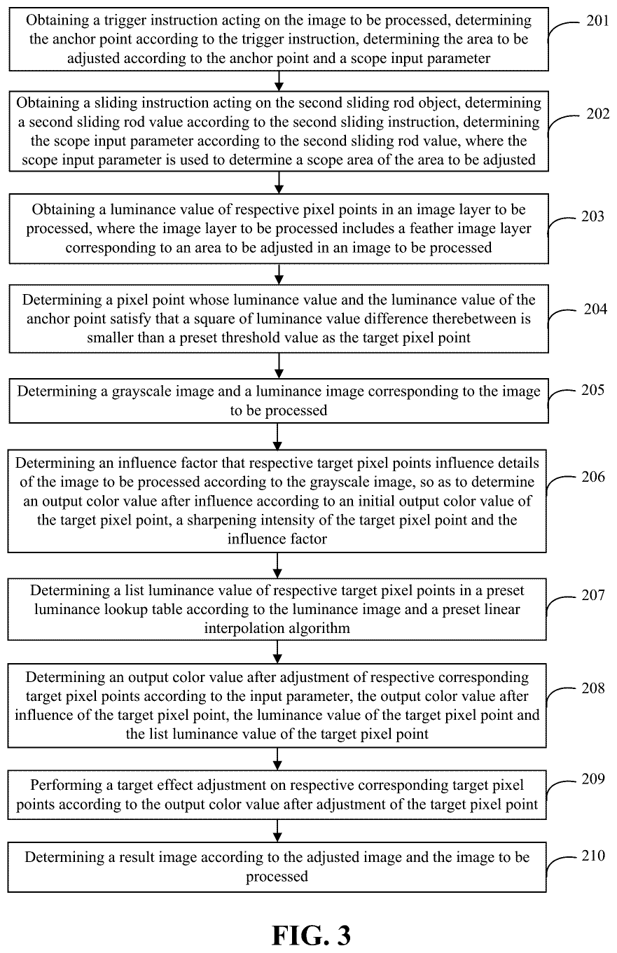

FIG. 3 is a schematic flowchart of an image processing method illustrated in an embodiment of the present disclosure. As illustrated in FIG. 3, the image processing method provided by the present embodiment includes:

Step 201: obtaining a trigger instruction acting on the image to be processed, determining the anchor point according to the trigger instruction, determining the area to be adjusted according to the anchor point and a scope input parameter.

When the user needs to perform a local processing on the image to be processed, a control point can be added to the image to be processed, for example, it can be selected by clicking on a touch screen of a terminal device, thereby generating a trigger instruction acting on the image to be processed. Then, the anchor point is determined according to the trigger instruction, and the area to be adjusted is determined according to the anchor point and a scope input parameter, and the anchor point may be an action point of clicking on the touch screen. Of course, the touch screen manner is only one of the trigger manners, and may also include a cursor selection manner, a coordinate input manner, and the like, and the input form of the trigger instruction is not specifically limited in the present embodiment.

Step 202: obtaining a sliding instruction acting on the second sliding rod object, determining a second sliding rod value according to a second sliding instruction, determining the scope input parameter according to the second sliding rod value, where the scope input parameter is used to determine a scope area of the area to be adjusted.

After the anchor point is determined, the user can input the parameter by sliding a sliding contact on the sliding rod. After obtaining the sliding instruction acting on the second sliding rod object, the terminal device determines the second sliding rod value according to the second sliding instruction, and determines a scope input parameter according to the second sliding rod value, where the scope input parameter is used to determine a scope area of the area to be adjusted. That is, by sliding the second sliding rod object, the adjustment of the scope of the area to be adjusted can be realized.

Step 203: obtaining a luminance value of respective pixel points in an image layer to be processed, where the image layer to be processed includes a feather image layer corresponding to an area to be adjusted in an image to be processed.

In this step, the luminance value of respective pixel points in the image layer to be processed can be obtained. Optionally, the pixel value of respective pixel points in the image layer to be processed can be first obtained, and then the pixel value is converted into the luminance value according to formula 1:

anchorLum=anchorColor.rgb*vec3(0.333,0.5,0.167); formula 1:
where anchorLum is the luminance value of a current pixel point, and anchorColor.rgb is the pixel value of the current pixel point; where 0.333, 0.5, and 0.167 are respective weight values of red (R), green (G), and blue (B) channels. By multiplying the RGB channels of a color image with the corresponding weight values above respectively, the color image can be converted into a corresponding grayscale image.

In addition, the image layer to be processed includes a feather image layer corresponding to the area to be adjusted in the image to be processed. It is worth noting that the feather image layer has a feathering effect, where the transparency of the feather image layer is gradually reduced from the center to the edge, which blurs an inner-and-outer connection portion the of the feather image layer and has a gradual change effect, so as to achieve an effect of natural connection. In this way, when adjusting the image layer to be processed, the effect of natural connection can be achieved between the image layer to be processed and other unprocessed areas in the image to be processed.

Step 204, determining a pixel point whose luminance value and the luminance value of the anchor point satisfy that a square of luminance value difference therebetween is smaller than a preset threshold value as the target pixel point.

Optionally, the first preset threshold relationship that the luminance value of the target pixel point and the luminance value of the anchor point satisfy may be that the square of the luminance value difference between the target pixel point and the anchor point is smaller than the preset threshold value.

If the square of the luminance value difference between the target pixel point and the anchor point is smaller than the preset threshold, the pixel adjustment is performed on the pixel point that satisfies this condition to achieve the effect of detail enhancement or detail blurring.

Step 205: determining a grayscale image and a luminance image corresponding to the image to be processed.

In this step, two texture images are calculated from the image to be processed: one is a grayscale image (identified as StereoS) and the other is a luminance image (identified as StereoH).

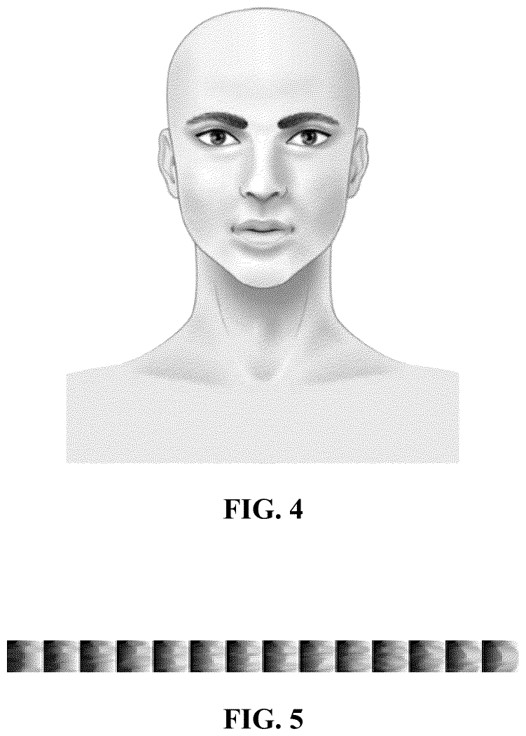

FIG. 4 is a schematic diagram of a grayscale image illustrated in an embodiment of the present disclosure. As illustrated in FIG. 4, the original color image to be processed can be converted into a corresponding grayscale image.

As for the generation of the luminance image, in a possible implementation, the image to be processed may be divided into multiple local images, and then each local image may be converted into corresponding luminance images, where, a size of the local image may be (srcWidth/W)*Height, and where srcWidth is an original width of the image to be processed, Height is a target height of the local image, and W is an equal division number in a width direction of the image to be processed.

FIG. 5 is a schematic diagram of a luminance image illustrated in an embodiment of the present disclosure. As illustrated in FIG. 5, the original color image to be processed can be divided into a plurality of local images (for example, 14 local images), and then corresponding luminance images are generated for these local images.

It is worth noting that by first dividing the image to be processed into a plurality of local images, and then converting them into corresponding luminance images, the processing speed is improved when the luminance images are used subsequently (for example, determining a list luminance value of respective target pixel points in a preset luminance lookup table using the luminance image and a preset linear interpolation algorithm). Specifically, the local image where the target pixel point is located may be first determined by the coordinate value of respective target pixel points. After that, when processing, only the luminance image corresponding to the local image needs to be used, which can greatly reduce the amount of calculation and improve the processing speed compared with directly using an overall luminance image corresponding to the image to be processed.

Step 206: determining an influence factor that respective target pixel points influence details of the image to be processed according to the grayscale image, so as to determine an output color value after influence according to an initial output color value of the target pixel point, a sharpening intensity of the target pixel point and the influence factor.

After the grayscale image is determined, the influence factor that respective target pixel points influence details of the image to be processed can be determined according to the grayscale image, where for the determination of the influence factor StereoRes that respective target pixel points influence the details of the image to be processed, the following formula 2 can be used:

StereoRes=srcLum−StereoS.a formula 2:
where StereoRes is the influence factor, srcLum is the luminance value of the target pixel point, and StereoS.a is the grayscale value of the target pixel point.

After determining the influence factor, the determination of the output color value after influence according to the initial output color value of the target pixel point, the sharpening intensity of the target pixel point and the influence factor can be determined by the following formula 3:

dstColor=scrColor+sharpenStrength*StereoRes formula 3:
where dstColor is the output color value after influence, scrColor is the initial output color value, and sharpenStrength is the sharpening intensity.

Step 207: determining a list luminance value of respective target pixel points in a preset luminance lookup table according to the luminance image and a preset linear interpolation algorithm.

In addition, the list luminance value of respective target pixel points in the preset luminance lookup table can also be determined according to the luminance image and a preset linear interpolation algorithm (for example, a single linear interpolation algorithm or a bilinear interpolation algorithm).

Step 208: determining an output color value after adjustment of respective corresponding target pixel points according to the input parameter, the output color value after influence of the target pixel point, the luminance value of the target pixel point and the list luminance value of the target pixel point.

The output color value after adjustment of respective corresponding target pixel points can be determined according to the input parameter, the initial output color value of the target pixel point, the luminance value of the target pixel point, and the list luminance value of the target pixel point. Specifically, formula 4 can be used to determine the output color value after adjustment:

finalColor=(dstColor−srcLum)*scale+srcLum−resVal formula 4:

where finalColor is the output color value after adjustment, dstColor is the output color value after influence, srcLum is the luminance value of the target pixel point, resVal is the list luminance value, and scale can be determined according to the input parameters and the following formulas:
when the input parameter is greater than 0,

scale=a*(intensity*intensity); formula 5:
when the input parameter is smaller than 0,

scale=b*(intensity*intensity); formula 6:
where a>0, for example, taking a value of 0.76; b<0, for example, taking a value of −0.4; intensity is an input parameter. Here, by using intensity*intensity for calculation, the parabolic characteristic of the quadratic function can be used, so that when the input parameters change, the value of scale can change more smoothly, thereby making the change of the output color value to be more smooth after adjustment.

It can be seen that when the input parameter is greater than 0, the scale is a positive value, and the output color value after the adjustment of the target pixel point in formula 4 is positively adjusted to achieve the effect of amplifying the details of the image and make the details prominent; when the input parameter is smaller than 0, the scale is a negative value, and the output color value after adjustment of the target pixel point in Formula 4 is negatively adjusted to achieve the effect of blurring the details of the image.

For the input parameter intensity, in a possible implementation, the first sliding instruction acting on the first sliding rod object can be obtained, and then the first sliding rod value is determined according to the first sliding instruction, and the first sliding rod value is used as the input parameter.

Correspondingly, if the first sliding rod value is greater than 0, the target effect adjustment is performed on the target pixel point to enhance the detail presentation degree of the image layer to be processed; if the first sliding rod value is smaller than 0, the target effect adjustment is performed on the target pixel point to blur the detail presentation degree of the image layer to be processed.

In addition, the first sliding rod value can also be used to determine the input parameter of the first target effect item. For example, the greater the first sliding rod value is, the greater the input parameter of the first target effect item is, and correspondingly, the stronger the realized target effect is.

Step 209: performing a target effect adjustment on respective corresponding target pixel points according to the output color value after adjustment of the target pixel point.

Specifically, the target effect adjustment is performed on the target pixel point according to the input parameter of the first target effect item to generate an adjusted image, where the first target effect item is used to represent the detail presentation degree of the image, the luminance value of the target pixel point and the luminance value of the anchor point satisfy the first preset threshold relationship, and the anchor point is the center point of the area to be adjusted. It should be noted that, in order to make the local processing effect more natural, a pixel point having the corresponding luminance value relationship with the center point of the area to be adjusted may be selected as the target pixel point for processing.

Step 210: determining a result image according to the adjusted image and the image to be processed.

After the adjusted image is generated, a result image may also be generated according to the adjusted image and the image to be processed, so as to present the processing effect of local detail enhancement or detail blurring in the result image.

Specifically, a mixing intensity of respective pixel points can be determined according to a transparency of respective pixel points in the feather image layer, and then the output color value after adjustment in the adjusted image and the initial output color value in the image to be processed can be mixed according to the mixing intensity of respective pixel points, so as to obtain the result image. The specific mixing manner can be implemented according to the following formula 7:

ResultColor=mix(srcColor,finalColor,mask.a) formula 7:
where ResultColor is the output color value of the result image; srcColor is the initial output color value, finalColor is the output color value after adjustment; mask.a is a scope corresponding to the feather image layer, including the mixing intensity of respective pixel points in the scope.

In order to better understand the processing effect of local detail enhancement or detail blurring in the above embodiments, the following examples can be used to illustrate.

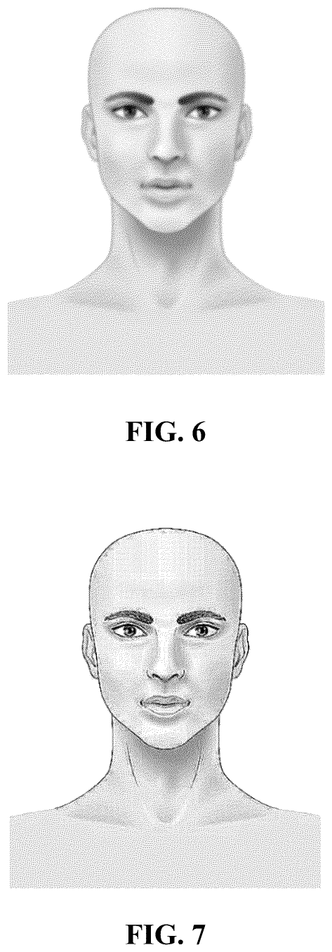

FIG. 6 is a schematic diagram of detail presentation degree blurring illustrated in an embodiment of the present disclosure, and FIG. 7 is a schematic diagram of detail presentation degree enhancement illustrated in an embodiment of the present disclosure. It is worth noting that FIG. 6 and FIG. 7 are schematic effect diagrams respectively illustrating the global detail presentation degree blurring and the global detail presentation degree enhancement of the image to be processed.

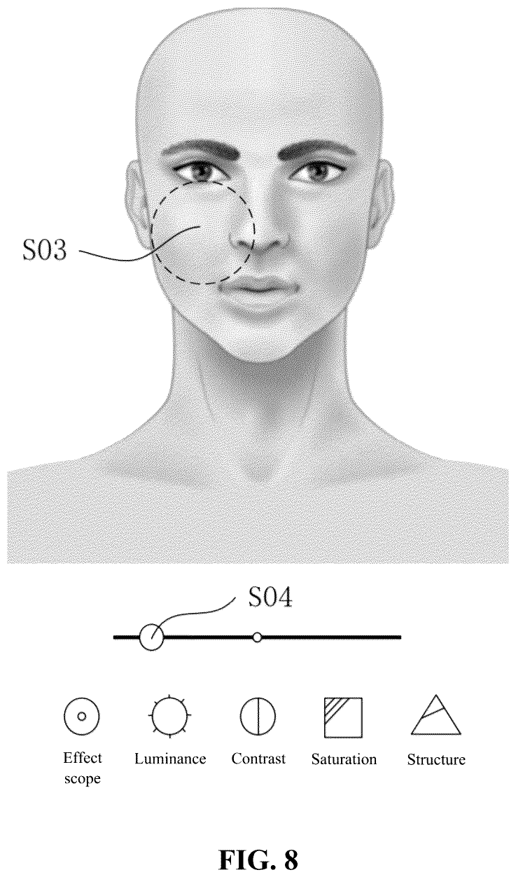

FIG. 8 is a schematic diagram of interface for adjusting a scope of an area to be adjusted illustrated in an embodiment of the present disclosure. As illustrated in FIG. 8, the scope input parameter can be input by sliding the sliding rod S04 to determine the scope of the image layer to be processed S03. Specifically, the sliding instruction acting on the second sliding rod object may be obtained, the second sliding rod value is determined according to the second sliding instruction, and then the above mentioned scope input parameter is determined according to the second sliding rod value.

In addition, in order to distinguish the above mentioned first sliding rod object and second sliding rod object, the functions realized by them can be described in combination, where the first sliding rod object is used to adjust the intensity of the first target effect item of the effect item. For example, by sliding the first sliding rod object, the target effect at a local position in the image can be adjusted. For example, the greater the first sliding rod value input for sliding the first sliding rod object is, the greater the input parameter of the first target effect item is, and correspondingly, the stronger the realized target effect is. While the above mentioned second sliding rod object is used to adjust the scope to be adjusted of the effect item. For example, by sliding the second sliding rod object, the scope area of the scope to be adjusted can be expanded or reduced.

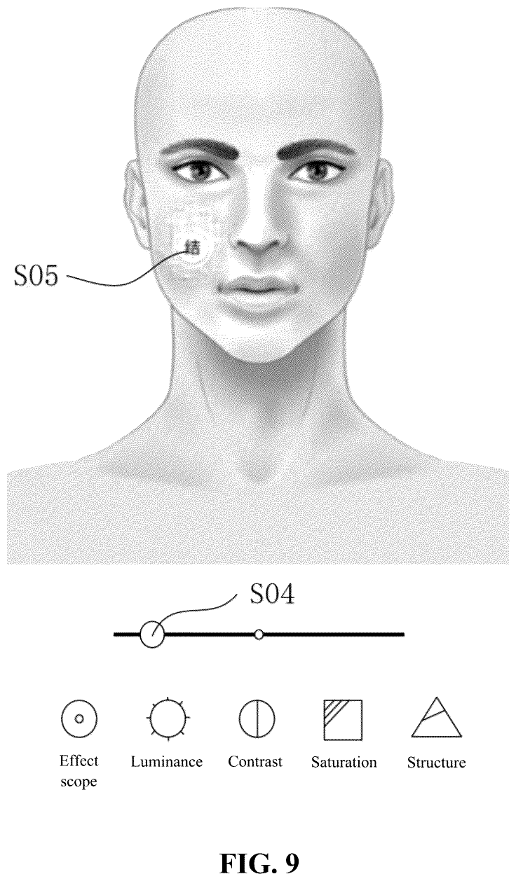

FIG. 9 is a schematic diagram of a result of local detail presentation degree of enhancement illustrated in an embodiment of the present disclosure. As illustrated in FIG. 9, in the first target effect item for adjusting the detail presentation degree, the first sliding rod value can be determined by sliding the sliding rod S04. Continuing to refer to FIG. 9, at this time, as illustrated in FIG. 9, the first sliding rod value is greater than 0, thus the detail presentation degree of the image layer to be processed is enhanced. After that, after generating the adjusted image, a result image is generated according to the adjusted image and the image to be processed, so as to present the processing effect of local detail enhancement in the result image, as illustrated in area S05 in FIG. 9. It can be seen that in the area S05 of FIG. 9, the effect of enhancing the detail presentation degree at the corresponding position in FIG. 7 is locally displayed.

On the basis of the above mentioned embodiments, the embodiments provided by the present disclosure can not only realize the detail presentation degree adjustment of a single local scope, but also can perform a detail presentation degree adjustment of multiple local scopes. For example, multiple control points can be added to the image to be processed, and different adjustments of the detail presentation degree for each control point can be performed.

It is worth noting that when performing detail presentation degree adjustments of multiple local scopes, the target effect adjustment may be performed on the target pixel point according to the first input parameter of the third target effect item, and then the target effect adjustment is further performed on the adjusted target pixel point according to the second input parameter of the fourth target effect item. That is, the first input parameter is used to adjust the third target effect item in the first image layer to be adjusted, the second input parameter is used to adjust the fourth target effect item in the second image layer to be adjusted, and the first area to be adjusted and the second area to be adjusted may correspond to different anchor points. It can be seen that the target pixel point belongs to the first image layer to be adjusted, and the target pixel point belongs to the second image layer to be adjusted, that is, the target pixel point is a common pixel point of the first image layer to be adjusted and the second image layer to be adjusted. At this time, the effect of each target pixel point is superimposed based on the effect that has been achieved previously, that is, the output of a previous effect is an input of the next one.

In the present embodiment, an anchor point is selected on the image to be processed by inputting a trigger instruction, and the scope area of the area to be adjusted is determined by sliding the second sliding rod object, so that the anchor point and the scope area are used jointly to determine the scope of area to be adjusted, and then the input parameter of the target effect item is determined by the means of sliding the first sliding rod object, so that the target effect adjustment is performed on the target pixel point according to the input parameter of the target effect item, so as to achieve the effect of magnifying or blurring image details at any local position in the image to be processed through users' simple operations.

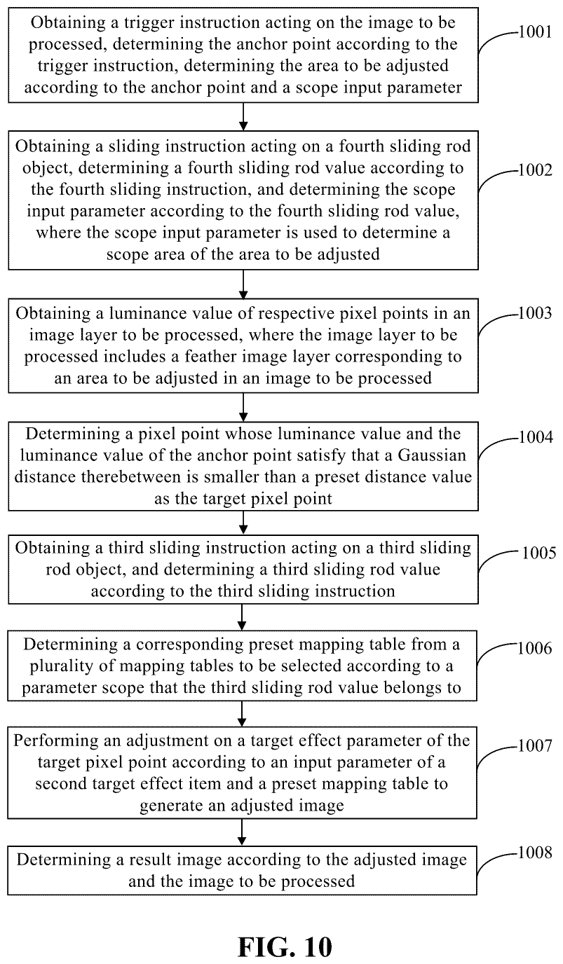

FIG. 10 is a schematic flowchart of the image processing method illustrated in an embodiment of the present disclosure. As illustrated in FIG. 10, the image processing method provided by the present embodiment includes:

Step 1001: obtaining a trigger instruction acting on the image to be processed, determining the anchor point according to the trigger instruction, determining the area to be adjusted according to the anchor point and a scope input parameter.

When the user needs to perform a local processing on the image to be processed, a control point can be added to the image to be processed, for example, it can be selected by clicking on a touch screen of a terminal device, thereby generating a trigger instruction acting on the image to be processed. Then, the anchor point is determined according to the trigger instruction. The anchor point may be an action point of clicking on the touch screen. Of course, the touch screen manner is only one of the trigger manners, and may also be a cursor selection manner, a coordinate input manner, and the like, and the input form of the trigger instruction is not specifically limited in the present embodiment.

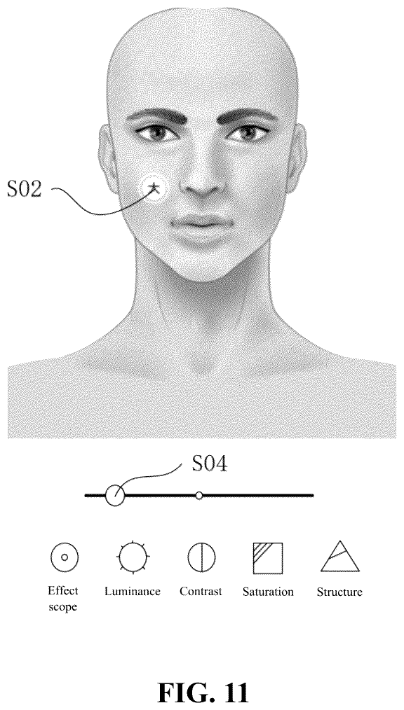

FIG. 11 is a schematic diagram of interface for selecting an area to be adjusted illustrated in an embodiment of the present disclosure. As illustrated in FIG. 11, the user can add a control point, that is, the first anchor point S02, on the image to be processed by clicking.

Step 1002: obtaining a sliding instruction acting on a fourth sliding rod object, determining a fourth sliding rod value according to a fourth sliding instruction, and determining the scope input parameter according to the fourth sliding rod value, where the scope input parameter is used to determine a scope area of the area to be adjusted.

Similar to the above step 202, after determining the anchor point, the user can input the parameter by sliding a sliding contact on the sliding rod. After obtaining the sliding instruction acting on the fourth sliding rod object, the terminal device determines the fourth sliding rod value according to the fourth sliding instruction, and determines a scope input parameter according to the fourth sliding rod value, where the scope input parameter is used to determine a scope area of the area to be adjusted. That is, by sliding the fourth sliding rod object, the adjustment of the scope of the area to be adjusted can be realized.

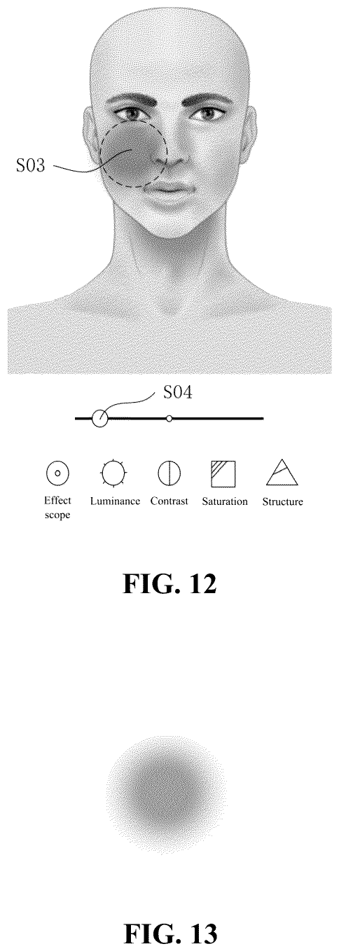

FIG. 12 is a schematic diagram of interface for adjusting a scope of an area to be adjusted illustrated in an embodiment of the present disclosure, and FIG. 13 is a schematic diagram of an image layer to be processed illustrated in an embodiment of the present disclosure. As illustrated in FIG. 12-FIG. 13, the scope input parameter can be input by sliding the sliding rod S04 to determine the scope of the image layer S03 to be processed. Specifically, the size of the scope of the area to be adjusted can be adjusted by sliding the sliding rod S04, and then the size of the scope of the image layer to be processed S03 corresponding to the area to be adjusted can be changed, where the image layer to be processed illustrated in FIG. 13 is a feather image layer corresponding to the area to be adjusted.

Step 1003: obtaining a luminance value of respective pixel points in an image layer to be processed, where the image layer to be processed includes a feather image layer corresponding to an area to be adjusted in an image to be processed.

In this step, the luminance value of respective pixel points in the image layer to be processed can be obtained. Optionally, the pixel value of respective pixel points in the image layer to be processed can be obtained first, and then the pixel value can be converted into luminance values according to formula 1:

anchorLum=anchorColor.rgb*vec3(0.333,0.5,0.167); formula 1:
where anchorLum is the luminance value of a current pixel point, and anchorColor.rgb is the pixel value of the current pixel point, where 0.333, 0.5 and 0.167 are respective weight values of red (R), green (G), and blue (B) channels. By multiplying the RGB channels of a color image with the corresponding weight values above respectively, the color image can be converted into a corresponding grayscale image.

In addition, the image layer to be processed includes a feather image layer corresponding to the area to be adjusted in the image to be processed. It is worth noting that the feather image layer has a feathering effect, where the transparency of the feather image layer is gradually reduced from the center to the edge, which blurs an inner-and-outer connection portion the of the feather image layer and has a gradual change effect, so as to achieve an effect of natural connection. In this way, when adjusting the image layer to be processed, the effect of natural connection can be achieved between the image layer to be processed and other unprocessed areas in the image to be processed.

Step 1004: determining a pixel point whose luminance value and the luminance value of the anchor point satisfy that a Gaussian distance therebetween is smaller than a preset distance value as the target pixel point.

Optionally, the second preset threshold value that the luminance value of the target pixel point and the luminance value of the anchor point needs to satisfy may include that the Gaussian distance between the luminance value of the target pixel point and the luminance value of the anchor point is smaller than the preset distance value. That is, if the Gaussian distance between the luminance value of the pixel point in the area to be adjusted and the luminance value of the anchor point is smaller than the preset distance value, it is determined that the pixel point is the above target pixel point.

If setting a square of Gaussian distance being smaller than the preset distance value as the second preset threshold relationship, the RGB (such as luminance, contrast, and the like) of the pixel point that satisfies the second preset threshold relationship will be adjusted, so that the target effect of the pixel point that satisfies within this threshold scope will be influenced, where the influence degree is determined jointly by the sliding rod value and the Gaussian distance. Specifically, the smaller the Gaussian distance is, the greater the influence degree is, and the greater the numerical value of the input parameter of the second target effect item is (for example, the greater the numerical value corresponding to the sliding rod value is), the greater the influence degree generated is. While, for pixel points that do not satisfy the second preset threshold relationship, their RGB values are not changed. By setting the above preset distance value as the threshold to screen the target pixel points, only the pixel points that satisfy the requirements are adjusted, so that the effect of local adjustment is more coordinated. For example, when the local (e.g. cheek) adjustment is made, the luminance value of the anchor point is greater, but there is an area with smaller luminance value (e.g. eyebrow) in the image layer to be processed. At this time, by setting the above preset distance value as the threshold, the pixel points in the cheek portion can be screened as the target pixel points for subsequent adjustment, while the eyebrow portion is not processed, so that the effect of local adjustment is more coordinated. Without setting the above preset distance value as the threshold, all the pixel points in the image layer to be processed will be processed indiscriminately, which will easily leads to the disharmony of the locally processed images.

For the above Gaussian distance, it can be calculated according to formula 8:

gaussDist=exp((srcLum−anchorLum)2/(−2.0)) formula 8:

where gaussDist is the Gaussian distance, srcLum is luminance value of pixel point, and anchorLum is luminance value of center point.

Step 1005: obtaining a third sliding instruction acting on a third sliding rod object, and determining a third sliding rod value according to the third sliding instruction.

Step 1006: determining a corresponding preset mapping table from a plurality of mapping tables to be selected according to a parameter scope that the third sliding rod value belongs to.

In this step, the third sliding instruction acting on the third sliding rod object can be obtained, and the third sliding rod value can be determined according to the third sliding instruction, and then the corresponding LUT can be determined according to the parameter scope that the third sliding rod value belongs to. Specifically, for each effect item, reference can be made to two LUT maps, i.e., positive LUT map and negative LUT map correspondingly, so as to realize the adjustment of the basic conditional effects of the image, such as contrast, luminance, saturation, light perception, color temperature, hue, and the like. It can be that when the sliding rod value is greater than 0, the positive LUT map is applied to obtain the effect of positive adjustment; when the sliding rod value is smaller than 0, the negative LUT map is applied to obtain the effect of negative adjustment.

In addition, the input parameter of the second target effect item can also be determined according to the third sliding rod value. For example, the greater the third sliding rod value is, the greater the input parameter of the second target effect item is, and correspondingly, the stronger the target effect realized is.

Besides, in order to distinguish the above mentioned third sliding rod object and fourth sliding rod object, the functions realized by them can be described in combination, where the third sliding rod object is used to adjust the presentation effect of the effect item. For example, by sliding the third sliding rod object, the contrast, luminance, saturation, light perception, color temperature, hue and the like at a local position in the image can be adjusted. For the above mentioned fourth sliding rod object, it is used to adjust the scope to be adjusted of the effect item. For example, by sliding the fourth sliding rod object, the scope area of the scope to be adjusted can be expanded or reduced.

Step 1007: performing an adjustment on a target effect parameter of the target pixel point according to an input parameter of a second target effect item and a preset mapping table to generate an adjusted image.

Specifically, after obtaining the luminance value of respective pixel points in the image layer to be processed, the target effect parameter of the target pixel point can be adjusted according to the input parameter of the second target effect item and the preset LUT to generate an adjusted image, where the luminance value of the target pixel point and the luminance value of the anchor point in the image layer to be processed satisfy the second preset threshold relationship, and the anchor point is the center point of the area to be adjusted. It is worth noting that, in order to make the effect of local processing more natural, pixel points with corresponding characteristic relationship with the center point of the area to be adjusted can be selected as target pixel points for processing. In addition, in the present embodiment, the above preset LUT can be configured according to the requirements of products and effects, so as to match different processing requirements.

Step 1008: determining a result image according to the adjusted image and the image to be processed.

After generating the adjusted image, it is necessary to generate the result image according to the adjusted image and the image to be processed, so as to present the processing effect of local adjustment in the result image.

Specifically, a mixing intensity of respective pixel points can be determined according to a transparency of respective pixel points in the feather image layer, and then the adjusted image and the image to be processed are mixed according to the mixing intensity of respective pixel points to obtain the above result image.

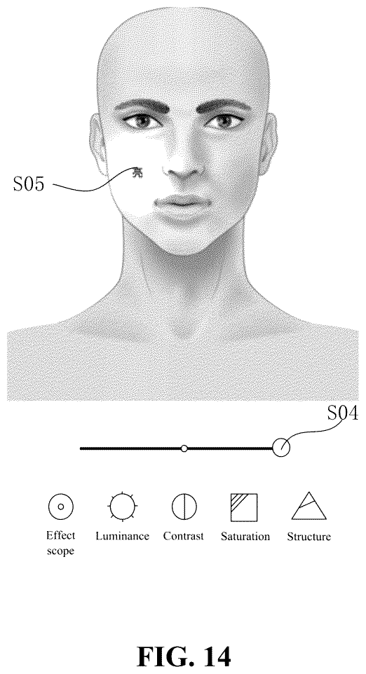

FIG. 14 is a schematic diagram of interface for adjusting single-item of image local illustrated in an embodiment of the present disclosure. As illustrated in FIG. 14, under a luminance item adjustment, an adjustment input parameter of the luminance can be determined by sliding the sliding rod S04, and the local area can be adjusted according to the adjustment input parameter of the luminance. Moreover, after the luminance item adjustment is triggered, the identifier on the first anchor point S02 will be changed to a luminance icon S05 corresponding to the luminance adjustment.

On the basis of the above embodiments, the embodiments provided by the present disclosure can not only realize the single-item adjustment of the image local, but also perform a multiple-items adjustment of image local. For example, multiple control points can be added to the image to be processed, and different target effect items adjustments can be performed for each control point. Specifically, a control point can be added to the image to be processed, the luminance adjustment can be performed for an area corresponding to the control point; another control point can be added to the image to be processed, and a saturation adjustment can be performed for another area corresponding to the control point.

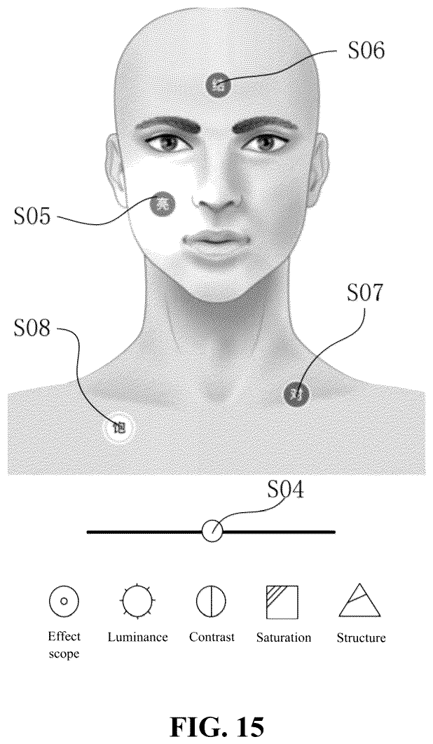

FIG. 15 is a schematic diagram of interface for adjusting multiple-items of image local illustrated in an embodiment of the present disclosure. As illustrated in FIG. 15, a luminance adjustment in a local scope (corresponding to S05), a structure adjustment in a local scope (corresponding to S06), a contrast adjustment in a local scope (corresponding to S07) and a saturation adjustment in a local scope (corresponding to S08) can be performed on the image to be processed, where the specific principles of structure adjustment, contrast adjustment and saturation adjustment are similar to those of luminance adjustment, and will not be described herein.

It is worth noting that, in the local multiple-items adjustment of the image, the first target effect parameter of the target pixel point can be adjusted according to the third input parameter of the fifth target effect item and the LUT, and then the second target effect parameter of the adjusted target pixel point can be continuously adjusted according to the fourth input parameter of the sixth target effect item and the LUT, where when the target pixel point belongs to both the third area to be adjusted and the fourth area to be adjusted (that is, when the target pixel point is the common pixel point of the third area to be adjusted and the fourth area to be adjusted), the effect of each target pixel point is superimposed based on the previously realized effect, that is, the output of a previous effect is an input of the next one.

Optionally, the third area to be adjusted and the fourth area to be adjusted may correspond to different anchor points or the same anchor point. In addition, the fifth target effect item and the sixth target effect item may be the same target effect item or different target effect items. For example, both the fifth target effect item and the sixth target effect item can be luminance adjustment, and in addition, the fifth target effect item can be luminance adjustment and the sixth target effect item can be saturation adjustment.

In the present embodiment, an anchor point is selected on the image to be processed by inputting a trigger instruction, and the scope area of the area to be adjusted is determined by sliding the fourth sliding rod object, so that the anchor point and the scope area are used jointly to determine the scope of area to be adjusted, and then the corresponding preset mapping table and the input parameter of the target effect item are determined by the means of sliding the third sliding rod object, so as to adjust the target effect parameter of the target pixel point within the scope of the area to be adjusted according to the input parameter of the target effect item and the preset mapping table, so as to achieve the technical effect that the effect adjustment at any local position in the image to be processed can be completed through simple user operation.

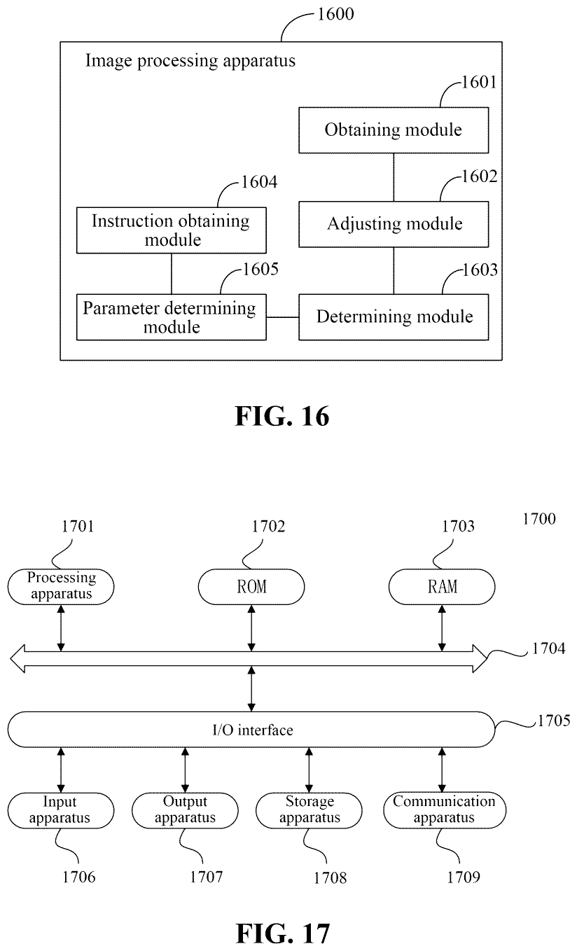

FIG. 16 is a schematic structural diagram of an image processing apparatus illustrated in an embodiment of the present disclosure. As illustrated in FIG. 16, the image processing apparatus 1600 provided by the present embodiment includes:
an obtaining module 1601, configured to obtain a luminance value of respective pixel points in an image layer to be processed, where the image layer to be processed includes a feather image layer corresponding to an area to be adjusted in an image to be processed;
a determining module 1603, configured to determine a pixel point in the image layer to be processed whose luminance value satisfies a first preset threshold relationship or a second preset threshold relationship with a luminance value of an anchor point in the area to be adjusted as a target pixel point; and
an adjusting module 1602, configured to, when determining a pixel point in the image layer to be processed whose luminance value satisfies the first preset threshold relationship with the luminance value of the anchor point in the area to be adjusted as the target pixel point, perform a target effect adjustment on the target pixel point according to an input parameter of a first target effect item to generate an adjusted image, where the first target effect item is used to represent a detail presentation degree of an image; and configured to, when determining a pixel point in the image layer to be processed whose luminance value satisfies the second preset threshold relationship with the luminance value of the anchor point in the area to be adjusted as the target pixel point, perform an adjustment on a target effect parameter of the target pixel point according to an input parameter of a second target effect item and a preset mapping table to generate an adjusted image; and
the determining module 1603 is further configured to determine a result image according to the adjusted image and the image to be processed.

In a possible design, the first preset threshold value relationship includes that a square of luminance value difference is smaller than a preset threshold value; and the second preset threshold value relationship includes that a Gaussian distance is smaller than a preset distance value.

According to one or more embodiments of the present disclosure, the anchor point is a center point of the area to be adjusted.

According to one or more embodiments of the present disclosure, before the performing the target effect adjustment on the target pixel point according to the input parameter of the first target effect item,
the obtaining module 1601 is further configured to obtain a first sliding instruction acting on a first sliding rod object, and
the determining module 1603 is further configured to determine a first sliding rod value according to the first sliding instruction, where the first sliding rod value is used to determine the input parameter of the first target effect item.

According to one or more embodiments of the present disclosure, if the first sliding rod value is greater than 0, the target effect adjustment is performed on the target pixel point, so as to enhance the detail presentation degree of the image layer to be processed;
if the first sliding rod value is smaller than 0, the target effect adjustment is performed on the target pixel point, so as to blur a detail presentation degree of the image layer to be processed.

According to one or more embodiments of the present disclosure, the adjusting module 1602 is specifically configured to:
perform the target effect adjustment on the target pixel point according to a first input parameter of a third target effect item; and
continue to perform the target effect adjustment on the adjusted target pixel point according to a second input parameter of a fourth target effect item, where the third target effect item and the fourth target effect item are different effect items.

According to one or more embodiments of the present disclosure, the third target effect item acts on a first area to be adjusted, the fourth target effect item acts on a second area to be adjusted, the target pixel point is a common pixel point of the first area to be adjusted and the second area to be adjusted, and the first area to be adjusted and the second area to be adjusted correspond to different anchor points.

According to one or more embodiments of the present disclosure, the adjusting module 1602 is specifically configured to:
determine a grayscale image and a luminance image corresponding to the image to be processed;
determine an influence factor that respective target pixel points influence details of the image to be processed according to the grayscale image;
determine an output color value after influence according to an initial output color value of the target pixel point, a sharpening intensity of the target pixel point and the influence factor;
determine a list luminance value of respective target pixel point in a preset luminance lookup table according to the luminance image and a preset linear interpolation algorithm;
determine an output color value after adjustment of respective corresponding target pixel points according to the input parameter, the output color value after influence of the target pixel point, the luminance value of the target pixel point and the list luminance value of the target pixel point; and
perform the target effect adjustment on respective corresponding target pixel points according to the output color value after adjustment of the target pixel point.

According to one or more embodiments of the present disclosure, when determining a pixel point in the image layer to be processed whose luminance value satisfies the first preset threshold relationship with the luminance value of the anchor point in the area to be adjusted as the target pixel point, the determining module 1603 is specifically configured to:
determine a mixing intensity of respective pixel points according to a transparency of respective pixel points in the feather image layer; and
mix the output color value after adjustment of respective pixel points in the adjusted image and the initial output color value of respective pixel points in the image to be processed according to the mixing intensity of respective pixel points, so as to obtain the result image.

According to one or more embodiments of the present disclosure, before the performing the target effect adjustment on the target pixel point according to the input parameter of the first target effect item, the obtaining module 1601 is further configured to obtain a trigger instruction acting on the image to be processed;
the determining module 1603 is further configured to determine the anchor point according to the trigger instruction; and
the determining module 1603 is further configured to determine the area to be adjusted according to the anchor point and a scope input parameter.

According to one or more embodiments of the present disclosure, the image processing apparatus 1600 provided by the present embodiment further includes:
an instruction obtaining module 1604, configured to obtain a sliding instruction acting on the second sliding rod object and determine a second sliding rod value according to a second sliding instruction; and
a parameter determining module 1605, configured to determine the scope input parameter according to the second sliding rod value, where the scope input parameter is used to determine a scope area of the area to be adjusted.

According to one or more embodiments of the present disclosure, before the performing the adjustment on the target effect parameter of the target pixel point according to the input parameter of the second target effect item and the preset mapping table,
the obtaining module 1601 is further configured to obtain a third sliding instruction acting on a third sliding rod object and determine a third sliding rod value according to the third sliding instruction; and
the determining module 1603 is further configured to determine a corresponding preset mapping table from a plurality of mapping tables to be selected according to a parameter scope that the third sliding rod value belongs to.

According to one or more embodiments of the present disclosure, after the determining the third sliding rod value according to the third sliding instruction,
the determining module 1603 is further configured to determine the input parameter of the second target effect item according to the third sliding rod value.

According to one or more embodiments of the present disclosure, the adjusting module 1602 is specifically configured to:
perform an adjustment on a first target effect parameter of the target pixel point according to a third input parameter of a fifth target effect item and the preset mapping table; and
continue to perform an adjustment on a second target effect parameter of the adjusted target pixel point according to a fourth input parameter of a sixth target effect item and the preset mapping table.

According to one or more embodiments of the present disclosure, the fifth target effect item acts on a third area to be adjusted, the sixth target effect item acts on a fourth area to be adjusted, the target pixel point is a common pixel point of the third area to be adjusted and the fourth area to be adjusted, and the third area to be adjusted and the fourth area to be adjusted correspond to different anchor points.

According to one or more embodiments of the present disclosure, when determining a pixel point in the image layer to be processed whose luminance value satisfies the second preset threshold relationship with the luminance value of the anchor point in the area to be adjusted as the target pixel point,
the determining module 1603 is specifically configured to:
determine a mixing intensity of respective pixel points according to a transparency of respective pixel points in the feather image layer; and
mix the adjusted image and the image to be processed according to the mixing intensity of respective pixel points, so as to obtain the result image.

According to one or more embodiments of the present disclosure, the second target effect item includes at least one of contrast, luminance, saturation, light perception, color temperature and hue. It is worth noting that the image processing apparatus provided by the embodiment illustrated in FIG. 16 can be used to execute the method provided by any of the above embodiments, and the specific implementation manner and technical effect are similar, so the details are not repeated herein.

FIG. 17 is a schematic structural diagram of an electronic device illustrated in an embodiment of the present disclosure. As illustrated in FIG. 17, it shows a schematic structural diagram of an electronic device 1700 suitable for implementing an embodiment of the present disclosure. The terminal devices in the embodiments of the present disclosure may include, but are not limited to, such as mobile phones, notebook computers, digital broadcast receivers, personal digital assistants (PDA), tablet computers (Portable Android Device, PAD), portable multimedia players (PMP), in-vehicle terminals (such as in-vehicle navigation terminals), wearable electronic devices, and other mobile terminals with image acquisition functions, as well as fixed terminals with image acquisition device externally connected, such as digital TVs, desktop computers, smart home devices, and the like. The electronic device illustrated in FIG. 17 is only an example, and should not impose any limitation on the function and scope of use of the embodiments of the present disclosure.

As illustrated in FIG. 17, the electronic device 1700 may include a processing apparatus (such as a central processing unit, a graphics processor, and the like) 1701, which may perform the above functions defined in the methods of the embodiments of the present disclosure according to a program stored in a read only memory (ROM) 1702 or a program loaded from a storage apparatus 1708 into a random access memory (RAM) 1703. In the RAM 1703, various programs and data necessary for the operation of the electronic device 1700 are also stored. The processing apparatus 1701, the ROM 1702, and the RAM 1703 are connected to each other through a bus 1704. An Input/Output (I/O) interface 1705 is also connected to the bus 1704.

Generally, the following apparatus may be connected to the I/O interface 1705: an input apparatus 1706 including, for example, a touch screen, a touch pad, a keyboard, a mouse, a camera, a microphone, an accelerometer, a gyroscope, and the like; an output apparatus 1707 including, for example, a Liquid Crystal Display (LCD), a speaker, a vibrator, and the like; a storage apparatus 1708 including, for example, a magnetic tape, a hard disk, and the like; and a communication apparatus 1709. The communication apparatus 1709 may allow electronic device 1700 to carry out wireless or wired communication with other device so as to exchange data. Although FIG. 17 shows an electronic device 1700 having various apparatuses, it should be understood that not all of the illustrated apparatuses are required to be implemented or provided. Alternatively, more or fewer apparatuses may be implemented or provided.

In particular, according to embodiments of the present disclosure, the processes described above with reference to the flowcharts may be implemented as computer software programs. For example, embodiments of the present disclosure include a computer program product including a computer program carried on a non-transitory computer readable medium, the computer program containing program code for performing the method illustrated in the flowchart. In such an embodiment, the computer program may be downloaded and installed from the network via the communication apparatus 1709, or may be installed from the storage apparatus 1708, or may be installed from the ROM 1702. When the computer program is executed by the processing apparatus 1701, the above functions defined in the methods of the embodiments of the present disclosure are executed.

It should be noted that the computer readable medium mentioned above in the present disclosure may be a computer readable signal medium or a computer readable storage medium, or any combination of the above two. The computer readable storage medium may be, for example, but is not limited to, an electrical, magnetic, optical, electromagnetic, infrared, or semiconductor system, apparatus or device, or any combination of the above. More specific examples of the computer readable storage medium may include, but are not limited to, an electrical connection with one or more wires, a portable computer disk, a hard disk, a random access memory (RAM), a read only memory (ROM), an erasable programmable read only memory (EPROM) or flash memory, an optical fiber, a portable compact disc read only memory (CD-ROM), an optical storage device, a magnetic storage device, or any suitable combination of the above. In the present disclosure, a computer readable storage medium may be any tangible medium that contains or stores a program, the program can be used by or in conjunction with an instruction execution system, apparatus, or device. And in the present disclosure, a computer readable signal medium may include a data signal propagated in baseband or as part of a carrier wave, and carries computer readable program codes. Such propagated data signals may take a variety of forms, including but not limited to an electromagnetic signal, an optical signal, or any suitable combination of the above. The computer readable signal medium may also be any computer readable medium other than a computer readable storage medium and can transmit, propagate, or transport the program for use by or in conjunction with the instruction execution system, apparatus, or device. The program codes included on the computer readable medium may be transmitted using any suitable medium including, but not limited to, an electrical wire, an optical cable, radio frequency (RF), and the like, or any suitable combination of the above.

In some embodiments, clients and servers can communicate using any currently known or future developed network protocol, such as Hyper Text Transfer Protocol (HTTP), and can communicate and interconnect with digital data in any form or medium (e.g., a communication network). Examples of communication networks include Local Area Network (Local Area Network, LAN), Wide Area Network (Wide Area Network, WAN), the Internet, and peer-to-peer networks (e.g., ad hoc peer-to-peer network), as well as any currently known or future developed networks.

The above computer readable medium may be included in the above electronic device; or may exist alone without being assembled into the electronic device.

The above computer readable medium carries one or more programs, and when the one or more programs are executed by the at least one processor, the above functions defined in the methods of the embodiments of the present disclosure can be implemented. For example: obtaining a luminance value of respective pixel points in an image layer to be processed, where the image layer to be processed includes a feather image layer corresponding to an area to be adjusted in an image to be processed; determining a pixel point in the image layer to be processed whose luminance value satisfies a first preset threshold relationship or a second preset threshold relationship with a luminance value of an anchor point in the area to be adjusted as a target pixel point; when determining a pixel point in the image layer to be processed whose luminance value satisfies the first preset threshold relationship with the luminance value of the anchor point in the area to be adjusted as the target pixel point, performing a target effect adjustment on the target pixel point according to an input parameter of a first target effect item to generate an adjusted image, where the first target effect item is used to represent a detail presentation degree of an image; when determining a pixel point in the image layer to be processed whose luminance value satisfies the second preset threshold relationship with the luminance value of the anchor point in the area to be adjusted as the target pixel point, performing an adjustment on a target effect parameter of the target pixel point according to an input parameter of a second target effect item and a preset mapping table to generate an adjusted image; and determining a result image according to the adjusted image and the image to be processed.

The computer program codes for carrying out operations of the present disclosure may be written in one or more programming languages or combination thereof, and the programming languages include but are not limited to object-oriented programming languages, such as Java, Smalltalk, C++, and conventional procedural programming languages, such as the “C” language or similar programming language. The program codes may be executed entirely on a user's computer, partly on the user's computer, as a stand-alone software package, both partly on the user's computer and partly on a remote computer, or entirely on a remote computer or a server. In the case of the remote computer, the remote computer can be connected to the user's computer through any kind of network, including a Local Area Network (LAN) or Wide Area Network (WAN), or can be connected to an external computer (e.g., using an internet service provider to connect via the internet).

The flowcharts and block diagrams in the accompanying drawings illustrate the architecture, functionality, and operation of possible implementations of systems, methods and computer program products according to various embodiments of the present disclosure. In this regard, each block in the flowcharts or block diagrams may represent a module, a program segment, or a part of code, and the module, the program segment, or the part of code contains one or more executable instructions for implementing a specified logical function. It should also be noted that, in some alternative implementations, the functions indicated in the blocks may occur in a different order than those indicated in the figures. For example, two blocks shown in succession may, in fact, be executed substantially concurrently, or may sometimes be executed in a reverse order, depending upon the function involved. It should also be noted that each block of the block diagrams and/or flowchart diagrams, and combinations of blocks in the block diagrams and/or flowchart diagrams, can be implemented by a dedicated hardware-based system for performing a specified function or operation, or can be implemented using a combination of dedicated hardware and computer instructions.

The units involved and described in the embodiments of the present disclosure may be implemented in a software manner, and may also be implemented in a hardware manner, where the name of the unit does not constitute a limitation of the unit itself under certain circumstances.

The functions described herein above may be performed, at least in part, by one or more hardware logic components. For example, without limitation, exemplary types of the hardware logic components that may be used include: field programmable gate array (FPGA), application specific integrated circuit (ASIC), application specific standard product (ASSP), system on chip (SOC), complex programmable logical device (CPLD), and the like.

In a first aspect, according to one or more embodiments of the present disclosure, an image processing method is provided, including:
obtaining a luminance value of respective pixel points in an image layer to be processed, where the image layer to be processed includes a feather image layer corresponding to an area to be adjusted in an image to be processed;
determining a pixel point in the image layer to be processed whose luminance value satisfies a first preset threshold relationship or a second preset threshold relationship with a luminance value of an anchor point in the area to be adjusted as a target pixel point;
when determining a pixel point in the image layer to be processed whose luminance value satisfies the first preset threshold relationship with the luminance value of the anchor point in the area to be adjusted as the target pixel point, performing a target effect adjustment on the target pixel point according to an input parameter of a first target effect item to generate an adjusted image, where the first target effect item is used to represent a detail presentation degree of an image;
when determining a pixel point in the image layer to be processed whose luminance value satisfies the second preset threshold relationship with the luminance value of the anchor point in the area to be adjusted as the target pixel point, performing an adjustment on a target effect parameter of the target pixel point according to an input parameter of a second target effect item and a preset mapping table to generate an adjusted image; and
determining a result image according to the adjusted image and the image to be processed.

According to one or more embodiments of the present disclosure, the first preset threshold value relationship includes that a square of luminance value difference is smaller than a preset threshold value; and the second preset threshold value relationship includes that a Gaussian distance is smaller than a preset distance value.

According to one or more embodiments of the present disclosure, the anchor point is a center point of the area to be adjusted.

According to one or more embodiments of the present disclosure, before the performing the target effect adjustment on the target pixel point according to the input parameter of the first target effect item, further including:
obtaining a first sliding instruction acting on a first sliding rod object, and determining a first sliding rod value according to the first sliding instruction, where the first sliding rod value is used to determine the input parameter of the first target effect item.

According to one or more embodiments of the present disclosure, if the first sliding rod value is greater than 0, performing the target effect adjustment on the target pixel point, so as to enhance the detail presentation degree of the image layer to be processed;
if the first sliding rod value is smaller than 0, performing the target effect adjustment on the target pixel point, so as to blur a detail presentation degree of the image layer to be processed.

According to one or more embodiments of the present disclosure, the performing the target effect adjustment on the target pixel point according to the input parameter of the first target effect item includes:
performing the target effect adjustment on the target pixel point according to a first input parameter of a third target effect item;
continuing to perform the target effect adjustment on the adjusted target pixel point according to a second input parameter of a fourth target effect item, where the third target effect item and the fourth target effect item are different effect items.

According to one or more embodiments of the present disclosure, the third target effect item acts on a first area to be adjusted, the fourth target effect item acts on a second area to be adjusted, the target pixel point is a common pixel point of the first area to be adjusted and the second area to be adjusted, and the first area to be adjusted and the second area to be adjusted correspond to different anchor points.

According to one or more embodiments of the present disclosure, the performing the target effect adjustment on the target pixel point according to the input parameter of the first target effect item includes:
determining a grayscale image and a luminance image corresponding to the image to be processed;
determining an influence factor that respective target pixel points influence details of the image to be processed according to the grayscale image;
determining an output color value after influence according to an initial output color value of the target pixel point, a sharpening intensity of the target pixel point and the influence factor;
determining a list luminance value of respective target pixel points in a preset luminance lookup table according to the luminance image and a preset linear interpolation algorithm;
determining an output color value after adjustment of respective corresponding target pixel points according to the input parameter, the output color value after influence of the target pixel point, the luminance value of the target pixel point and the list luminance value of the target pixel point;
performing the target effect adjustment on respective corresponding target pixel points according to the output color value after adjustment of the target pixel point.

According to one or more embodiments of the present disclosure, when determining a pixel point in the image layer to be processed whose luminance value satisfies the first preset threshold relationship with the luminance value of the anchor point in the area to be adjusted as the target pixel point, the determining the result image according to the adjusted image and the image to be processed includes:
determining a mixing intensity of respective pixel points according to a transparency of respective pixel points in the feather image layer;
mixing the output color value after adjustment in the adjusted image and the initial output color value in the image to be processed according to the mixing intensity of respective pixel points, so as to obtain the result image.

According to one or more embodiments of the present disclosure, before the performing the target effect adjustment on the target pixel point according to the input parameter of the first target effect item, further including:
obtaining a trigger instruction acting on the image to be processed;
determining the anchor point according to the trigger instruction;
determining the area to be adjusted according to the anchor point and a scope input parameter.

According to one or more embodiments of the present disclosure, before the determining the area to be adjusted according to the anchor point and the scope input parameter, further including:
obtaining a sliding instruction acting on the second sliding rod object, and determining a second sliding rod value according to the second sliding instruction;
determining the scope input parameter according to the second sliding rod value, where the scope input parameter is used to determine a scope area of the area to be adjusted.

According to one or more embodiments of the present disclosure, before the performing the adjustment on the target effect parameter of the target pixel point according to the input parameter of the second target effect item and the preset mapping table, further including:
obtaining a third sliding instruction acting on a third sliding rod object, and determining a third sliding rod value according to the third sliding instruction;
determining a corresponding preset mapping table from a plurality of mapping tables to be selected according to a parameter scope that the third sliding rod value belongs to.

According to one or more embodiments of the present disclosure, after the determining the third sliding rod value according to the third sliding instruction, further including:
determining the input parameter of the second target effect item according to the third sliding rod value.

According to one or more embodiments of the present disclosure, the performing the adjustment on the target effect parameter of the target pixel point according to the input parameter of the second target effect item and the preset mapping table includes:
performing an adjustment on a first target effect parameter of the target pixel point according to a third input parameter of a fifth target effect item and the preset mapping table;
continuing to perform an adjustment on a second target effect parameter of the adjusted target pixel point according to a fourth input parameter of a sixth target effect item and the preset mapping table.

According to one or more embodiments of the present disclosure, the fifth target effect item acts on a third area to be adjusted, the sixth target effect item acts on a fourth area to be adjusted, the target pixel point is a common pixel point of the third area to be adjusted and the fourth area to be adjusted, and the third area to be adjusted and the fourth area to be adjusted correspond to different anchor points.

According to one or more embodiments of the present disclosure, when determining a pixel point in the image layer to be processed whose luminance value satisfies the second preset threshold relationship with the luminance value of the anchor point in the area to be adjusted as the target pixel point, the determining the result image according to the adjusted image and the image to be processed includes:
determining a mixing intensity of respective pixel points according to a transparency of respective pixel points in the feather image layer;
mixing the adjusted image and the image to be processed according to the mixing intensity of respective pixel points, so as to obtain the result image.

According to one or more embodiments of the present disclosure, the second target effect item includes at least one of contrast, luminance, saturation, light perception, color temperature and hue.

In a second aspect, according to one or more embodiments of the present disclosure, an image processing apparatus is provided, including:
an obtaining module, configured to obtain a luminance value of respective pixel points in an image layer to be processed, where the image layer to be processed includes a feather image layer corresponding to an area to be adjusted in an image to be processed;
a determining module, configured to determine a pixel point in the image layer to be processed whose luminance value satisfies a first preset threshold relationship or a second preset threshold relationship with a luminance value of an anchor point in the area to be adjusted as a target pixel point; and
an adjusting module, configured to, when determining a pixel point in the image layer to be processed whose luminance value satisfies the first preset threshold relationship with the luminance value of the anchor point in the area to be adjusted as the target pixel point, perform a target effect adjustment on the target pixel point according to an input parameter of a first target effect item to generate an adjusted image, where the first target effect item is used to represent a detail presentation degree of an image; and configured to, when determining a pixel point in the image layer to be processed whose luminance value satisfies the second preset threshold relationship with the luminance value of the anchor point in the area to be adjusted as the target pixel point, perform an adjustment on a target effect parameter of the target pixel point according to an input parameter of a second target effect item and a preset mapping table to generate an adjusted image; and
the determining module is further configured to determine a result image according to the adjusted image and the image to be processed.

In a possible design, the first preset threshold value relationship includes that a square of luminance value difference is smaller than a preset threshold value; and the second preset threshold value relationship includes that a Gaussian distance is smaller than a preset distance value.

According to one or more embodiments of the present disclosure, the anchor point is a center point of the area to be adjusted.

According to one or more embodiments of the present disclosure, before the performing the target effect adjustment on the target pixel point according to the input parameter of the first target effect item,
the obtaining module is further configured to a first sliding instruction acting on a first sliding rod object; and
the determining module is further configured to determine a first sliding rod value according to the first sliding instruction, where the first sliding rod value is used to determine the input parameter of the first target effect item.

According to one or more embodiments of the present disclosure, if the first sliding rod value is greater than 0, the target effect adjustment is performed on the target pixel point, so as to enhance the detail presentation degree of the image layer to be processed;
if the first sliding rod value is smaller than 0, the target effect adjustment is performed on the target pixel point, so as to blur a detail presentation degree of the image layer to be processed.

According to one or more embodiments of the present disclosure, the adjusting module is specifically configured to:
perform the target effect adjustment on the target pixel point according to a first input parameter of a third target effect item; and
continue to perform the target effect adjustment on the adjusted target pixel point according to a second input parameter of a fourth target effect item, where the third target effect item and the fourth target effect item are different effect items.

According to one or more embodiments of the present disclosure, the third target effect item acts on a first area to be adjusted, the fourth target effect item acts on a second area to be adjusted, the target pixel point is a common pixel point of the first area to be adjusted and the second area to be adjusted, and the first area to be adjusted and the second area to be adjusted correspond to different anchor points.

According to one or more embodiments of the present disclosure, the adjusting module is specifically configured to:
determine a grayscale image and a luminance image corresponding to the image to be processed;
determine an influence factor that respective target pixel points influence details of the image to be processed according to the grayscale image;
determine an output color value after influence according to an initial output color value of the target pixel point, a sharpening intensity of the target pixel point and the influence factor;
determine a list luminance value of respective target pixel points in a preset luminance lookup table according to the luminance image and a preset linear interpolation algorithm;
determine an output color value after adjustment of respective corresponding target pixel points according to the input parameter, the output color value after influence of the target pixel point, the luminance value of the target pixel point and the list luminance value of the target pixel point; and
perform the target effect adjustment on respective corresponding target pixel points according to the output color value after adjustment of the target pixel point.

According to one or more embodiments of the present disclosure, when determining a pixel point in the image layer to be processed whose luminance value satisfies the first preset threshold relationship with the luminance value of the anchor point in the area to be adjusted as the target pixel point, the determining module is specifically configured to:
determine a mixing intensity of respective pixel points according to a transparency of respective pixel points in the feather image layer; and
mix the output color value after adjustment in the adjusted image and the initial output color value in the image to be processed according to the mixing intensity of respective pixel points, so as to obtain the result image.

According to one or more embodiments of the present disclosure, before the performing the target effect adjustment on the target pixel point according to the input parameter of the first target effect item,
the obtaining module is further configured to obtain a trigger instruction acting on the image to be processed;
the determining module is further configured to determine the anchor point according to the trigger instruction; and
the determining module is further configured to determine the area to be adjusted according to the anchor point and a scope input parameter.

According to one or more embodiments of the present disclosure, the image processing apparatus provided by the present embodiment further includes:
an instruction obtaining module, configured to obtain a sliding instruction acting on the second sliding rod object and determine a second sliding rod value according to a second sliding instruction; and
a parameter determining module, configured to determine the scope input parameter according to the second sliding rod value, where the scope input parameter is used to determine a scope area of the area to be adjusted.

According to one or more embodiments of the present disclosure, before the performing the adjustment on the target effect parameter of the target pixel point according to the input parameter of the second target effect item and the preset mapping table,
the obtaining module is further configured to obtain a third sliding instruction acting on a third sliding rod object and determine a third sliding rod value according to the third sliding instruction; and
the determining module is further configured to determine a corresponding preset mapping table from a plurality of mapping tables to be selected according to a parameter scope that the third sliding rod value belongs to.

According to one or more embodiments of the present disclosure, after the determining the third sliding rod value according to the third sliding instruction, the determining module is further configured to determine the input parameter of the second target effect item according to the third sliding rod value.

According to one or more embodiments of the present disclosure, the adjusting module is specifically configured to:
perform an adjustment on a first target effect parameter of the target pixel point according to a third input parameter of a fifth target effect item and the preset mapping table; and
continue to perform an adjustment on a second target effect parameter of the adjusted target pixel point according to a fourth input parameter of a sixth target effect item and the preset mapping table.

According to one or more embodiments of the present disclosure, the fifth target effect item acts on a third area to be adjusted, the sixth target effect item acts on a fourth area to be adjusted, the target pixel point is a common pixel point of the third area to be adjusted and the fourth area to be adjusted, and the third area to be adjusted and the fourth area to be adjusted correspond to different anchor points.

According to one or more embodiments of the present disclosure, when determining a pixel point in the image layer to be processed whose luminance value satisfies the second preset threshold relationship with the luminance value of the anchor point in the area to be adjusted as the target pixel point,
the determining module is specifically configured to:
determine a mixing intensity of respective pixel points according to a transparency of respective pixel points in the feather image layer; and
mix the adjusted image and the image to be processed according to the mixing intensity of respective pixel point, so as to obtain the result image.

According to one or more embodiments of the present disclosure, the second target effect item includes at least one of contrast, luminance, saturation, light perception, color temperature and hue.

In a third aspect, the present disclosure also provides an electronic device, including:
at least one processor; and
a memory, configured to store executable instructions of the at least one processor;
where the at least one processor is configured to execute any one of the possible image processing methods in the first aspect by executing the executable instructions.

In a fourth aspect, an embodiment of the present disclosure further provides a computer readable storage medium on which a computer program is stored; and the computer program, when executed by at least one processor, implements any one of the possible image processing methods in the first aspect.

In a fifth aspect, an embodiment of the present disclosure further provides a computer program product on which a computer program is stored; and the computer program, when executed by at least one processor, implements any one of the possible image processing methods in the first aspect.

In a sixth aspect, an embodiment of the present disclosure provides a computer program, which, when executed by at least one processor, implements any one of the possible image processing methods in the first aspect.

In the context of the present disclosure, a machine readable medium may be a tangible medium and may contain or store a program for use by or in conjunction with an instruction execution system, apparatus or device. The machine readable medium may be a machine readable signal medium or a machine readable storage medium. The machine readable medium may include, but is not limited to, an electronic, magnetic, optical, electromagnetic, infrared, or semiconductive system, apparatus, or device, or any suitable combination of the above. More specific examples of the machine readable storage medium may include an electrical connection based on one or more wires, a portable computer disk, a hard disk, a random access memory (RAM), a read only memory (ROM), an erasable programmable read only memory (EPROM) or flash memory, an optical fiber, a portable compact disk read only memory (CD-ROM), an optical storage device, a magnetic storage device, or any suitable combination of the above.

The above descriptions are merely preferred embodiments of the present disclosure and illustrations of the technical principles employed. Those skilled in the art should understand that the scope of disclosure involved in the present disclosure is not limited to the technical solutions formed by specific combinations of the above technical features, and should cover other technical solutions formed by any combination of the above technical features or equivalent features thereof without departing from the above disclosed concept. For example, a technical solution is formed by replacing the above features with the technical features having similar functions disclosed in the present disclosure (but not limited thereto).

Additionally, although operations are depicted in a particular order, this should not be construed as requiring that the operations are performed in the particular order shown or in a sequential order. Under certain circumstances, multitasking and parallel processing may be advantageous. Likewise, although the above description contains several specific implementation details, which should not be construed as limitations on the scope of the present disclosure. Certain features described in the context of separate embodiments can also be implemented in combination in a single embodiment. Conversely, various features described in the context of a single embodiment can also be implemented in multiple embodiments separately or in any suitable subcombination.

Although the subject matters have been described by a language specific to structural features and/or method logical actions, it should be understood that the subject matters defined in the appended claims is not necessarily limited to specific features or actions described above. Rather, the specific features and actions described above are merely examples for implementing the claims.

1. An image processing method, comprising:
obtaining a luminance value of respective pixel points in an image layer to be processed, wherein the image layer to be processed comprises a feather image layer corresponding to an area to be adjusted in an image to be processed;
determining a pixel point in the image layer to be processed whose luminance value satisfies a first preset threshold relationship or a second preset threshold relationship with a luminance value of an anchor point in the area to be adjusted as a target pixel point;
when determining a pixel point in the image layer to be processed whose luminance value satisfies the first preset threshold relationship with the luminance value of the anchor point in the area to be adjusted as the target pixel point, performing a target effect adjustment on the target pixel point according to an input parameter of a first target effect item to generate an adjusted image, wherein the first target effect item is used to represent a detail presentation degree of an image;
when determining a pixel point in the image layer to be processed whose luminance value satisfies the second preset threshold relationship with the luminance value of the anchor point in the area to be adjusted as the target pixel point, performing an adjustment on a target effect parameter of the target pixel point according to an input parameter of a second target effect item and a preset mapping table to generate an adjusted image; and
determining a result image according to the adjusted image and the image to be processed.

2. The image processing method according to claim 1, wherein the first preset threshold value relationship comprises that a square of luminance value difference is smaller than a preset threshold value; and the second preset threshold value relationship comprises that a Gaussian distance is smaller than a preset distance value.

3. The image processing method according to claim 2, wherein the anchor point is a center point of the area to be adjusted.

4. The image processing method according to claim 1, wherein before the performing the target effect adjustment on the target pixel point according to the input parameter of the first target effect item, further comprising:
obtaining a first sliding instruction acting on a first sliding rod object, and determining a first sliding rod value according to the first sliding instruction, wherein the first sliding rod value is used to determine the input parameter of the first target effect item.

5. The image processing method according to claim 4, wherein if the first sliding rod value is greater than 0, performing the target effect adjustment on the target pixel point, so as to enhance the detail presentation degree of the image layer to be processed;
if the first sliding rod value is smaller than 0, performing the target effect adjustment on the target pixel point, so as to blur the detail presentation degree of the image layer to be processed.

6. The image processing method according to claim 1, wherein the performing the target effect adjustment on the target pixel point according to the input parameter of the first target effect item comprises:
performing the target effect adjustment on the target pixel point according to a first input parameter of a third target effect item;
continuing to perform the target effect adjustment on the adjusted target pixel point according to a second input parameter of a fourth target effect item, wherein the third target effect item and the fourth target effect item are different effect items.

7. The image processing method according to claim 6, wherein the third target effect item acts on a first area to be adjusted, the fourth target effect item acts on a second area to be adjusted, the target pixel point is a common pixel point of the first area to be adjusted and the second area to be adjusted, and the first area to be adjusted and the second area to be adjusted correspond to different anchor points.

8. The image processing method according to claim 1, wherein the performing the target effect adjustment on the target pixel point according to the input parameter of the first target effect item comprises:
determining a grayscale image and a luminance image corresponding to the image to be processed;
determining an influence factor that respective target pixel points influence details of the image to be processed according to the grayscale image;
determining an output color value after influence according to an initial output color value of the target pixel point, a sharpening intensity of the target pixel point and the influence factor;
determining a list luminance value of respective target pixel points in a preset luminance lookup table according to the luminance image and a preset linear interpolation algorithm;
determining an output color value after adjustment of respective corresponding target pixel points according to the input parameter, the output color value after influence of the target pixel point, the luminance value of the target pixel point and the list luminance value of the target pixel point;
performing the target effect adjustment on respective corresponding target pixel points according to the output color value after adjustment of the target pixel point.

9. The image processing method according to claim 1, wherein when determining a pixel point in the image layer to be processed whose luminance value satisfies the first preset threshold relationship with the luminance value of the anchor point in the area to be adjusted as the target pixel point, the determining the result image according to the adjusted image and the image to be processed comprises:
determining a mixing intensity of respective pixel points according to a transparency of respective pixel points in the feather image layer;
mixing an output color value after adjustment of respective pixel points in the adjusted image and an initial output color value of respective pixel points in the image to be processed according to the mixing intensity of respective pixel points, so as to obtain the result image.

10. The image processing method according to claim 1, wherein before the performing the target effect adjustment on the target pixel point according to the input parameter of the first target effect item, further comprising:
obtaining a trigger instruction acting on the image to be processed;
determining the anchor point according to the trigger instruction;
determining the area to be adjusted according to the anchor point and a scope input parameter.

11. The image processing method according to claim 10, wherein before the determining the area to be adjusted according to the anchor point and the scope input parameter, further comprising:
obtaining a sliding instruction acting on the second sliding rod object, and determining a second sliding rod value according to a second sliding instruction;
determining the scope input parameter according to the second sliding rod value, wherein the scope input parameter is used to determine a scope area of the area to be adjusted.

12. The image processing method according to claim 1, wherein before the performing the adjustment on the target effect parameter of the target pixel point according to the input parameter of the second target effect item and the preset mapping table, further comprising:
obtaining a third sliding instruction acting on a third sliding rod object, and determining a third sliding rod value according to the third sliding instruction;
determining a corresponding preset mapping table from a plurality of mapping tables to be selected according to a parameter scope that the third sliding rod value belongs to.

13. The image processing method according to claim 12, wherein after the determining the third sliding rod value according to the third sliding instruction, further comprising:
determining the input parameter of the second target effect item according to the third sliding rod value.

14. The image processing method according to claim 1, wherein the performing the adjustment on the target effect parameter of the target pixel point according to the input parameter of the second target effect item and the preset mapping table comprises:
performing an adjustment on a first target effect parameter of the target pixel point according to a third input parameter of a fifth target effect item and the preset mapping table;
continuing to perform an adjustment on a second target effect parameter of the adjusted target pixel point according to a fourth input parameter of a sixth target effect item and the preset mapping table.

15. The image processing method according to claim 14, wherein the fifth target effect item acts on a third area to be adjusted, the sixth target effect item acts on a fourth area to be adjusted, the target pixel point is a common pixel point of the third area to be adjusted and the fourth area to be adjusted, and the third area to be adjusted and the fourth area to be adjusted correspond to different anchor points.

16. The image processing method according to claim 1, wherein when determining a pixel point in the image layer to be processed whose luminance value satisfies the second preset threshold relationship with the luminance value of the anchor point in the area to be adjusted as the target pixel point, the determining the result image according to the adjusted image and the image to be processed comprises:
determining a mixing intensity of respective pixel points according to a transparency of respective pixel points in the feather image layer;
mixing the adjusted image and the image to be processed according to the mixing intensity of respective pixel points, so as to obtain the result image.

17. The image processing method according to claim 1, wherein the second target effect item comprises at least one of contrast, luminance, saturation, light perception, color temperature and hue.

18. An image processing apparatus, comprising: at least one processor, a memory, an input apparatus and an output apparatus;
the memory stores computer executable instructions;
the at least one processor executes the computer executable instructions stored in the memory, so as to enable the at least one processor to:
control the input apparatus to obtain a luminance value of respective pixel points in an image layer to be processed, wherein the image layer to be processed comprises a feather image layer corresponding to an area to be adjusted in an image to be processed;
determine a pixel point in the image layer to be processed whose luminance value satisfies a first preset threshold relationship or a second preset threshold relationship with a luminance value of an anchor point in the area to be adjusted as a target pixel point;
when determining a pixel point in the image layer to be processed whose luminance value satisfies the first preset threshold relationship with the luminance value of the anchor point in the area to be adjusted as the target pixel point, perform a target effect adjustment on the target pixel point according to an input parameter of a first target effect item to generate an adjusted image, wherein the first target effect item is used to represent a detail presentation degree of an image; and when determining a pixel point in the image layer to be processed whose luminance value satisfies the second preset threshold relationship with the luminance value of the anchor point in the area to be adjusted as the target pixel point, perform an adjustment on a target effect parameter of the target pixel point according to an input parameter of the second target effect item and a preset mapping table to generate an adjusted image; and
determine a result image according to the adjusted image and the image to be processed.

19. An electronic device, comprising: at least one processor and a memory;
the memory stores computer executable instructions;
the at least one processor executes the computer executable instructions stored in the memory, so as to enable the at least one processor to execute the image processing method according to claim 1.

20. A non-transitory computer readable storage medium, wherein computer executable instructions are stored in the computer readable storage medium, and the computer executable instructions, when executed by at least one processor, implement the image processing method according to claim 1.
